(19) United States
(12) Patent Application Publication
(10) Pub. No.: US 2021/0347268 A1
(43) Pub. Date: Nov. 11, 2021

(54) MULTIDIMENSIONAL UV POWER RELAY AND CHARGING NETWORK

(71) Applicant: AT&T Intellectual Property I, L.P., Atlanta, GA (US)

(72) Inventors: Di Chou, Colts Neck, NJ (US); Eric Noble, Lancaster, CA (US)

(21) Appl. No.: 16/867,889

(22) Filed: May 6, 2020

(51) Int. Cl. B60L 53/12; H04W 4/40; H04W 4/029

(52) U.S. Cl. CPC B60L 53/12; H04W 4/40; B64C 39/024; B60L 2200/10; B60L 2200/32; H04W 4/029

(57) ABSTRACT

A system for supplying power to an unmanned vehicle, which may be from a dynamically controlled remote power source. A power provider may wirelessly supply power to substantially hemispherical power acceptors or substantially spherical power acceptors. Power may be wirelessly supplied using beams of electromagnetic radiation, such as microwaves or laser beams.

### BACKGROUND

Today a large number of companies are greatly expanding their use of unmanned vehicles (UVs), which include unmanned aerial vehicles (UAVs). UAVs have been used for military applications, search-and-rescue missions, scientific research, delivering goods, and other uses. UAVs can include a plurality of airborne platforms or air vehicles, each carrying a plurality of sensors that may be used to collect information about an area under surveillance or to deliver a payload to a certain location. The airborne platforms may communicate with users, which may include persons or equipment, that desire access to data collected by the sensors or desire to control the UAV. More sophisticated UAVs have built-in control and/or guidance systems to perform low-level human pilot duties, such as speed and flight path surveillance, and simple pre-scripted navigation functions.

This background information is provided to reveal information believed by the applicant to be of possible relevance. No admission is necessarily intended, nor should be construed, that any of the preceding information constitutes prior art.

### SUMMARY

UVs may be mobile platforms capable of performing automated actions. UVs may be used in many different ways. For example, UVs may be used to provide communication network services, such as Wi-Fi, LTE, 5G, etc. for mobile devices, especially during the period when tradition cell towers are not functioning. However, these UVs require power to maintain functionality, which usually comes in the form of a rechargeable battery or other fuel source. Disclosed herein is a system for supplying power to a UV, which may be from a dynamically controlled remote power source.

An adaptive and fault-tolerant system for supplying power to an unmanned vehicle, which may be from an AI based, dynamically controlled remote power source. A power provider may wirelessly supply power to substantially hemispherical power acceptors or substantially full spherical power acceptors. Power may be wirelessly supplied using concentrated beams of electromagnetic radiation, such as laser beams or concentrated natural light. Adaptive behavior may be provided via artificial intelligence from within the power provider network control layer and may include mesh capabilities for supporting resource balancing during demand fluctuations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for a multidimensional UV power relay and charging network.

FIG. 2 illustrates an exemplary power acceptor.

FIG. 3 illustrates an exemplary power acceptor.

FIG. 4 illustrates an exemplary method for a multidimensional UV power relay and charging network.

FIG. 5 illustrates an exemplary system for a multidimensional UV power relay and charging network.

FIG. 6 illustrates a schematic of an exemplary network device.

FIG. 7 illustrates an exemplary communication system that provides wireless telecommunication services over wireless communication networks.

### DETAILED DESCRIPTION

UVs may be mobile platforms capable of performing automated actions. UVs may be used in many different ways. For example, UVs may be used to provide communication network services, such as WIFI, LTE, 5G, etc. for mobile devices, especially during the period when tradition cell towers are not functioning. However, these UVs require power to maintain functionality, which usually comes in the form of a rechargeable battery or other fuel source. Disclosed herein is a system for supplying power to a UV, which may be from a dynamically controlled remote power source.

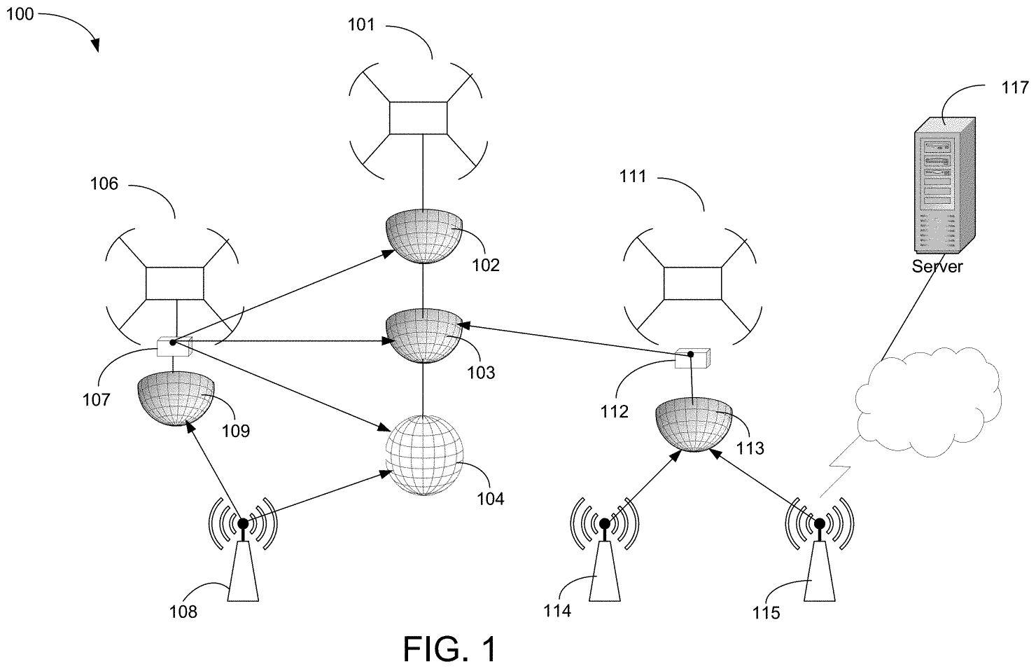

FIG. 1 illustrates an exemplary system for a multidimensional UV power relay and charging network. System 100 may include a plurality of UVs, such as UV 101, UV 106, or UV 111. UV 101, UV 106, or UV 111 may be communicatively connected with each other or base station power providers, such as base station power provider 108, base station power provider 114, or base station power provider 115. As shown, UV 101 may be connected with spherical power acceptors, such as hemispherical power acceptor 102, hemispherical power acceptor 103, or spherical power acceptor 104. Spherical power acceptors may use electromagnetic energy which includes radio waves, microwaves, infrared, light, ultraviolet, X-rays, or gamma rays. Spherical power acceptors may use photovoltaics. Hemispherical power acceptor 102, hemispherical power acceptor 103, or spherical power acceptor 104 may be connected with UV 101 or each other in series or in parallel using a physical power channel. UV 106 may be connected with power provider 107 or hemispherical power acceptor 109. UV 111 may be connected with power provider 112 or hemispherical power acceptor 113. Server 117 may be communicatively connected with the UVs or base stations to assist with the management of supply energy to or from the devices in system 100.

With continued reference to FIG. 1, base station power provider 108, base station power provider 114, base station power provider 115, power provider 107, or power provider 111 may wirelessly supply power to any of the hemispherical power acceptors or spherical power acceptors. Power may be wirelessly supplied using beams of electromagnetic radiation, such as laser beams or concentrated natural light.

Server 117 may include a power control system that may use an artificial intelligence platform coordinating power providers or power acceptors real time. The power control system may use the wireless networks (e.g., Wi-Fi or 5G) to receive the related data from the network elements, analyze the data, and provides the optimum charging configuration, which may establish a network of power channels terminated on the in-need UV. The power control system of server 117 may then send the commands to each involved element (e.g., power provider, power acceptor, or UV) to start the charging. The power control system of server 117 may monitor the configuration and status (e.g., charging rate of wireless wave at current position), and perform adjustment if necessary. Moreover, unpredictable events (e.g., accidents), less-predicable events such as weather conditions (e.g., wind, rain, etc.), payloads (e.g., items carried for delivery, sensors attached to the drones, etc.), or geographic conditions (e.g., landforms including hills that may affect the charging configuration currently being executed) may cause the power control system of server 117 to constantly adjust the configuration.

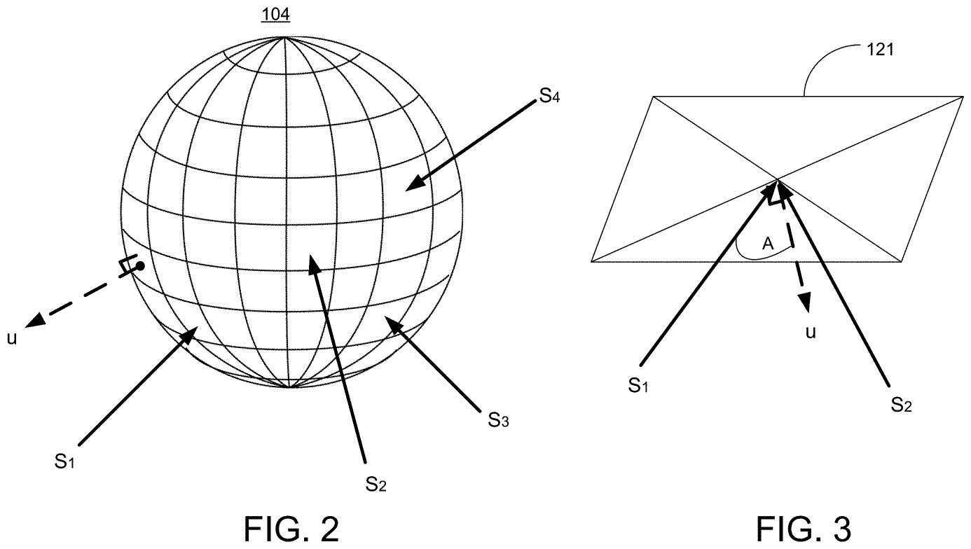

FIG. 2 illustrates an exemplary spherical power acceptor 104. Spherical power acceptor 104 may be used to supply power to UV or other devices in response to a wireless beam connecting with the surface of spherical power acceptor 104. A spherical power acceptor (whether half or full sphere) is preferred because it is more efficient to accept power when the beam arrives at close to a 90-degree angle. As shown in FIG. 2, normal vectors (u) in approximately all directions. Further, the S vectors may have Smax*cos (90)=Smax. Therefore, there are several directions a beam may hit the surface of spherical power acceptor 104 that may lead to maximum acceptance. Alternatively, as shown in FIG. 3, a power acceptor 121, may be non-spherical (e.g., a plane, rectangular, triangular, etc.). Although such non-spherical shapes may be used, power acceptor 121 has only its normal vector (u) in a single direction. Therefore, one direction to the source has the maximum acceptance (Smax), while other directions will have Smax*cos (A).

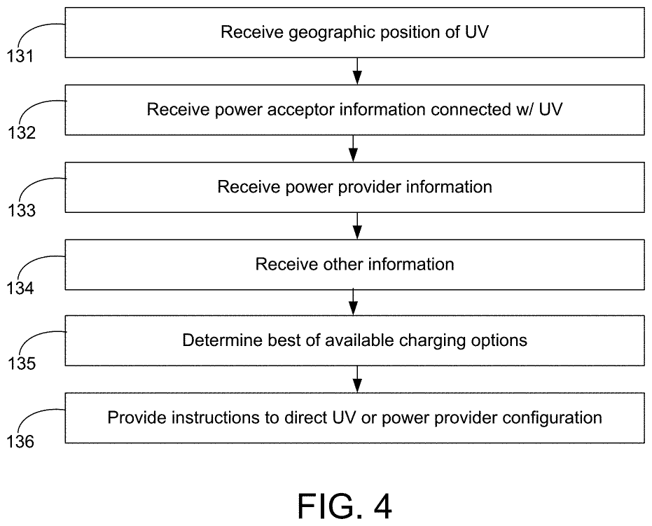

FIG. 4 illustrates an exemplary method for a multidimensional UV power relay and charging network. At step 131, server 117 may receive a geographic information associated with one or more UVs, such as UV 101, UV 106, or UV 111. This geographic information may include longitude, latitude, or altitude. In addition, the geographic information may include characteristics of the terrain (e.g., obstructions) at a geographic position, such as mountains, valleys, buildings, trees, roads, or bodies of water, among other things. At step 132, server 117 may receive power acceptor information associated with UVs of step 131. For example, the number of power acceptors connected with UV 106, the relative position of the power acceptors to UV 106 (e.g., how far above or below UV 106), or the shape of the power acceptor for UV 106 (e.g., hemispherical, spherical, or a polygon), among other things.

With continued reference to FIG. 4, at step 133, server 117 may receive power provider information. The power provider information may include geographic position of the power provider (e.g., base station power provider 108 or power provider 107). The power provider information may also include the rate of power output, or wireless range (e.g., in length or angle) of the wireless beams of the power provider devices, among other things. At step 134, server 117 may receive other information (which may overlap with the information of steps 131-133), such as power requirement of UVs, or time requirement (e.g., based on travel plan of UV), availability of power acceptors or power providers, among other things.

With continued reference to FIG. 4, at step 135, determine available charging options that are within an acceptable threshold. An acceptable threshold may be within an acceptable range of one or more requirements, such as geographical position, time requirements (e.g., charging significantly faster than battery is depleted), or the like. In an example, UV 106 may determine that base station power provider 108 fits such requirements and therefore may coordinate UV 106 and base station power provider 108 in a manner for optimal power acceptance. In a more complex example, as shown in FIG. 1, there may be multiple different UVs and base stations that may be coordinated to provide for optimal power acceptance. At step 136, based on the determination of step 135, server 117 may send message to the UVs (e.g., UV 106) or power providers (e.g., base station power provider 108) in order to coordinate the wireless power transfer and acceptance.

It is contemplated herein that the UVs may be water, land, or air-based. It is also contemplated that the vehicles may be manned. Further, although a base station power provider is disclosed as a source of power, it is contemplated that power supplying devices connected with telephone poles, street light poles, or buildings, among other things may be used. The steps herein, such as associated with FIG. 4, may be executed on one device or distributed of multiple devices.

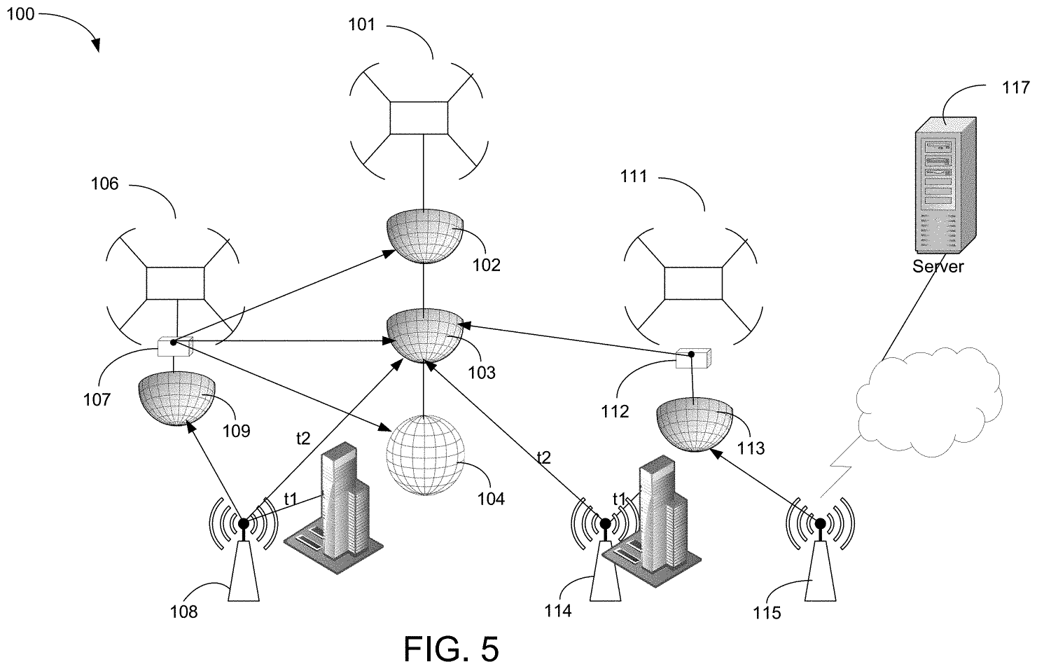

FIG. 5 illustrates an exemplary system for a multidimensional UV power relay and charging network. In this example, obstructions (e.g., a building) or issues may cause power to not be effectively relayed to spherical power acceptor 1113 or spherical power acceptor 104. The issues may be associated with the dynamics of objects moving in a 3-D space according to time or due to events such as weather or terrain changes. In this example of FIG. 5, obstruction 125 and obstruction 126 may be obstacles that block the transmission at time t1. At time t2 the laser, for example, may be redirected or another wireless power source may be found while be directed in line of sight (LoS) towards a spherical power acceptor (e.g., spherical power acceptor 103). Server 117 may use artificial intelligence or machine learning for driving the network charging system to reestablish power transmission connections dynamically, in a fault-tolerant manner, as at time t2. Please note the established connections do not have to be the same as the previous type, such as different types of electromagnetic radiation.

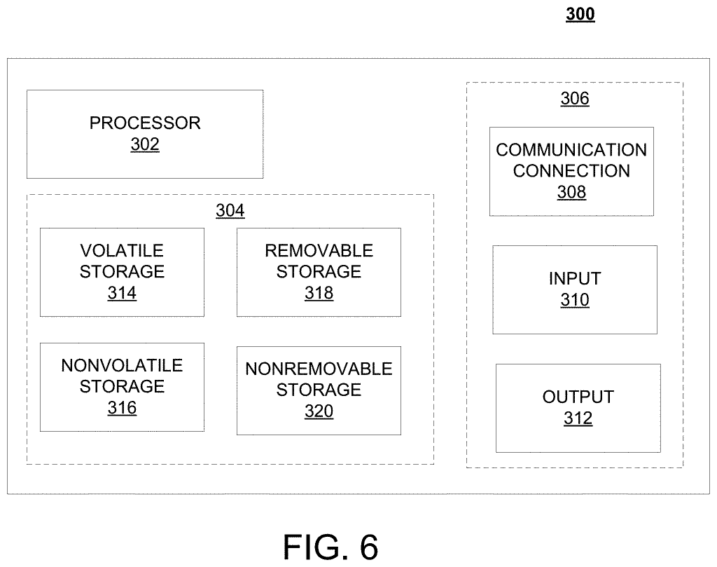

FIG. 6 is a block diagram of network device 300 that may be connected to or comprise a component of FIG. 1-FIG. 4. Network device 300 may comprise hardware or a combination of hardware and software. The functionality to facilitate telecommunications via a telecommunications network may reside in one or combination of network devices 300. Network device 300 depicted in FIG. 6 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 6 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 6) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

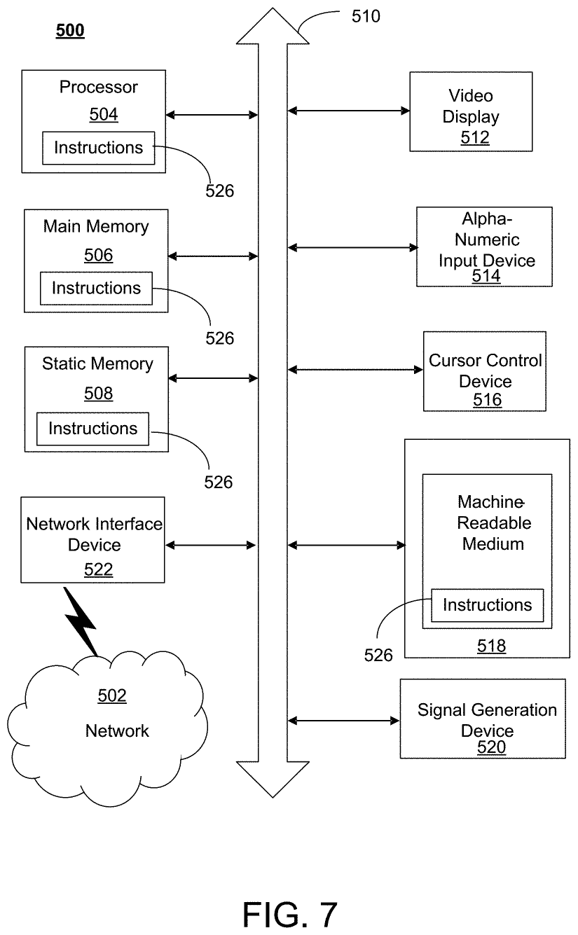

FIG. 7 depicts an exemplary diagrammatic representation of a machine in the form of a computer system 500 within which a set of instructions, when executed, may cause the machine to perform any one or more of the methods described above. One or more instances of the machine can operate, for example, as processor 302, UV 101, UV 106, power provider 107, base station power provider 108, server 117 and other devices of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—multi-dimensional UV power relay or charging network—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for a multi-dimensional UV power relay or charging network. A power acceptor apparatus, wherein the power acceptor apparatus comprises a spherical shape, wherein the power acceptor apparatus receives a wireless wave for generating power, and wherein the power acceptor transfers the generated power from the wireless power wave to a battery of the vehicle. The power acceptor apparatus may be attached to vehicle or other structure. The spherical shape may be substantially hemi-spherical (e.g., approximately 50% of the entirety) or substantially spherical (e.g., approximately 80% of the entirety).

What is claimed:

1. A vehicle, the vehicle comprising:
a power acceptor apparatus,
wherein the power acceptor apparatus comprises a spherical shape,
wherein the power acceptor apparatus receives a wireless wave for generating power, and
wherein the power acceptor apparatus transfers the generated power from the wireless power wave to a battery of the vehicle.

2. The vehicle of claim 1, wherein the spherical shape is substantially hemi-spherical.

3. The vehicle of claim 1, wherein the vehicle further comprises a wireless power provider that wirelessly transfers power to another power acceptor apparatus of another vehicle.

4. The vehicle of claim 1, wherein the vehicle further comprises a wireless power provider that wirelessly transfers power from the power acceptor apparatus to another power acceptor apparatus.

5. The vehicle of claim 1, wherein the vehicle is an unmanned vehicle.

6. The vehicle of claim 1, wherein the vehicle is an autonomous vehicle.

7. The vehicle of claim 1, wherein the wireless wave is from a power provider of a base station.

8. The vehicle of claim 1, wherein the wireless wave is from a power provider of another vehicle.

9. The vehicle of claim 1, the vehicle further comprises another power acceptor apparatus.

10. The vehicle of claim 1, the vehicle further comprises another power acceptor apparatus, wherein the another power acceptor apparatus is a substantially spherical shape.

11. The vehicle of claim 1, the vehicle is an aerial-based vehicle or water-based vehicle.

12. The vehicle of claim 1, the vehicle further comprising:
one or more processors; and
memory coupled with the one or more processors, the memory storing executable instructions that when executed by the one or more processors cause the one or more processors to effectuate operations comprising:
receiving instructions to move to a geographic position in order to accept the wireless wave for generating power.

13. The vehicle of claim 1, the vehicle further comprising:
one or more processors; and
memory coupled with the one or more processors, the memory storing executable instructions that when executed by the one or more processors cause the one or more processors to effectuate operations comprising:
sending information that comprises a first geographic position of the vehicle; and
based on the sending of the information, receiving instructions to move to a second geographic position in order to accept the wireless wave for generating power.

14. The vehicle of claim 1, the vehicle further comprising:
one or more processors; and
memory coupled with the one or more processors, the memory storing executable instructions that when executed by the one or more processors cause the one or more processors to effectuate operations comprising:
sending information that comprises a battery charge level of the vehicle; and
based on the sending of the information, receiving instructions to move to a second geographic position in order to accept the wireless wave for generating power.

15. The vehicle of claim 1, the vehicle further comprising:
one or more processors; and
memory coupled with the one or more processors, the memory storing executable instructions that when executed by the one or more processors cause the one or more processors to effectuate operations comprising:
sending information that comprises a configuration of the power acceptor apparatus; and
based on the sending of the information, receiving instructions to move to a second geographic position in order to accept the wireless wave for generating power.

16. The vehicle of claim 1, the vehicle further comprising:
one or more processors; and
memory coupled with the one or more processors, the memory storing executable instructions that when executed by the one or more processors cause the one or more processors to effectuate operations comprising:
sending information that comprises a charging rate based on the wireless wave; and
based on the sending of the information, receiving instructions to move to a second geographic position in order to accept the wireless wave for generating power.

17. The vehicle of claim 1, the vehicle further comprising:
one or more processors; and
memory coupled with the one or more processors, the memory storing executable instructions that when executed by the one or more processors cause the one or more processors to effectuate operations comprising:
sending information that comprises a wind information associated with a geographic position of the vehicle; and
based on the sending of the information, receiving instructions to move to a second geographic position in order to accept the wireless wave for generating power.

18. The vehicle of claim 1, the vehicle further comprising:
one or more processors; and
memory coupled with the one or more processors, the memory storing executable instructions that when executed by the one or more processors cause the one or more processors to effectuate operations comprising:
sending information that comprises geographic conditions associated with a terrain near the vehicle; and
based on the sending of the information, receiving instructions to move to a second geographic position in order to accept the wireless wave for generating power.

19. The vehicle of claim 1, the vehicle further comprising:
one or more processors; and
memory coupled with the one or more processors, the memory storing executable instructions that when executed by the one or more processors cause the one or more processors to effectuate operations comprising:
sending information that comprises a power requirement for the vehicle; and
based on the sending of the information, receiving instructions to move to a second geographic position in order to accept the wireless wave for generating power.

20. The vehicle of claim 1, the vehicle further comprising:
one or more processors; and
memory coupled with the one or more processors, the memory storing executable instructions that when executed by the one or more processors cause the one or more processors to effectuate operations comprising:
sending information that comprises a time requirement associated with the vehicle; and
based on the sending of the information, receiving instructions to move to a second geographic position in order to accept the wireless wave for generating power.
